(19) United States
(12) Patent Application Publication
(10) Pub. No.: US 2011/0055004 A1
(43) Pub. Date: Mar. 3, 2011

(54) METHOD AND SYSTEM FOR SELECTING AND OPTIMIZING BID RECOMMENDATION ALGORITHMS

(76) Inventor: Bradd Elden Libby, Hope Valley, RI (US)

(21) Appl. No.: 12/552,797

(22) Filed: Sep. 2, 2009

(51) Int. Cl. G06Q 30/00; G06Q 10/00

(52) U.S. Cl. 705/14.45; 705/14.46; 705/14.54; 705/14.71

(57) ABSTRACT

A system and method are provided for evaluating the performance of at least one algorithm that generates bid recommendations for keyword advertising on search engines. According to one example, metric data associated with a plurality of internet advertisement objects is divided into a plurality of similar object groups. In one example, these object groups are provided to one or more client devices. In one example, the client devices generate bid recommendations according to at least one algorithm and place the bids with search engines. In still another example, the performance of the at least one bid recommendation algorithm is later measured or compared to the performance of another bid recommendation algorithm.

### BACKGROUND

1. Field of the Invention

The present invention relates generally to internet searching and ad exchange networks. More particularly, aspects of the present invention relate to placing advertisements on networks.

2. Discussion of Related Art

Search engines such as those offered by GOOGLE, Inc., (Mountain View, Calif.), YAHOO!, Inc. (Sunnyvale, Calif.), the Microsoft Corporation, (Redmond, Wash.), among others have become valuable tools, both for consumers performing searches and advertisers wishing to market themselves to those consumers. These search engines provide “natural” search results, which may be generated by proprietary algorithms that evaluate the relevance of a number of indexed web pages in relation to a user's search terms and deliver a list of results in decreasing order of relevancy. Additionally, users may be presented with a selection of “sponsored” search results that permit advertisers to reach users through search engine results.

Typically, a sponsored result is a link to a website associated with an advertiser who has paid to have an advertisement displayed in response to a search on one or more particular keywords. More than one sponsored result may be displayed in response to a given search, and advertisers may pay a higher cost to display their advertisement in a more prominent position among these sponsored results with the knowledge that the better position may lead to more traffic to their website. Users selecting an advertisement (e.g., by clicking on the advertisement) may be taken to a specific page on the advertiser's website, for example, where they may be able to view other advertisements, purchase goods, sign up to receive information, or otherwise affiliate or transact with the advertiser. The advertiser or other party may track these interactions, thus being able to associate a user's click on a particular advertisement with a sale, lead, or other measurable activity of value to the advertiser.

There are other types of systems for delivering advertisements that are not related to a search engine function. For instance, there are advertisement exchange networks that permit advertisers to bid for placing graphical ads on participating websites (e.g., Google AdSense). Websites that display such ads may earn revenue in exchange for access to the website's viewers.

### SUMMARY

An advertiser attempting to continuously manage and update bids for thousands of keywords may quickly become overwhelmed and desire a bid recommendation system and method similar to the ones described above for guiding and administering the bidding process. Bid recommendation systems exist that recommend bid amounts for internet keywords (or other unit of advertisement) based on desired net margins, profitability, prominence of the associated advertisement, and trending data about the performance of the keyword over time. By using such systems, the advertiser can increase bids on those keywords that are likely to generate more revenue or profit, and can decrease bids for those keywords that have not been to as effective. Also, there are people that use such systems that provide recommendations to clients for placing bids on particular keywords and groups of keywords.

However, there is presently no method or system for evaluating the relative performance of bid recommendation algorithms incorporated into these bid recommendation systems. Such an evaluation would be useful for optimizing those systems, or evaluating the people that use such systems to provide bid recommendations for clients. Further, such an evaluation may be useful for identifying a system that performs the best according to some measure, such as generating bid recommendations offering the greatest profitability, net margin, return on investment (ROI), or number of times that advertisements associated with the keywords (or other unit of advertising such as a textual phrase, a hyperlink, a textual advertisement, a graphic advertisement, advertisement position in a display, or any other advertising object as is known in the art) are displayed to users. According to various aspects consistent with principles of the present invention, systems and methods are provided for evaluating the performance of one or more bid recommendation algorithms according to one or more criteria.

According to one aspect of the present invention, it is beneficial to evaluate the relative performance of several different bid recommendation algorithms. In this way, a preferred bid recommendation algorithm may be selected from the group according to some measure of success. It may also be beneficial to evaluate the relative performance of one bid recommendation algorithm when it is performed according to one or more different parameters or variables. An optimal set of parameters or variables may then be selected for improved performance of the bid recommendation algorithm. In either case, a test may be conducted in which the bid recommendation algorithms are run on sets of keywords to generate bids. These bids may then be placed with a search engine (or ad network), and, after some amount of time, the performance of the algorithms may be evaluated according to some measure of the performance of the keywords (or other advertising unit) and bids.

According to one aspect, each bid recommendation algorithm is responsible for generating a bid that is placed on a particular keyword (or other advertising unit). It would be undesirable to have competing bids being placed on behalf of the same advertiser. Thus, each keyword can only be assigned to one participating bid recommendation algorithm for the duration of the test. Therefore, it may be desirable to create a group of unique keywords for each bid recommendation algorithm.

To evaluate the performance of the algorithms, it may be desirable to minimize or eliminate any differences in performance that may be attributable to differences in the keywords assigned to each algorithm. By minimizing the differences between the groups of keywords themselves, one can be more certain that any observed differences are a result of the characteristics of the algorithms themselves. Therefore, it may be desirable to create groups that perform as similarly as possible in one or more aspects. For example, if algorithms being tested for their performance on keywords that are associated with advertisements that are clicked a relatively high number of times, then it may be desirable to create groups of keywords having similarly high numbers of clicks associated with these groups.

According to another aspect consistent with principles of the present invention, it may be desirable to evaluate the performance of bid recommendation algorithms by examining the performance over time of the bids generated by such algorithms. For example, it may be possible to calculate profitability, return on investment, or other measures associated with the keywords for which a bid has been placed. A search engine may assign quality scores or other measures which may also be used as the basis for evaluation. Each algorithm can be evaluated on the basis of the performance of the keywords for which the algorithm has generated bids, and the results can be compared. In this way, the algorithm or parameters that deliver the best results can be identified, and further action can be taken to improve the performance of bid recommendations.

According to one aspect of the present invention, a method is provided for evaluating at least one bid recommendation algorithm. The method includes acts of retrieving a first metric data set associated with a plurality of internet advertisement objects, dividing the plurality of internet advertisement objects and the first metric set into a plurality of object groups, providing a first object group to a first client device, providing a second object group to a second client device, retrieving a second metric data set associated with the plurality of internet advertisement objects, and measuring the performance of the at least one bid recommendation algorithm with respect to the second metric data set.

According to one embodiment, the at least one bid recommendation algorithm may include a first bid recommendation algorithm and a second bid recommendation algorithm, and may further include acts of applying the first bid recommendation algorithm to the first object group, and applying the second bid recommendation algorithm to the second object group. In a further embodiment, the method may further include the act of placing a bid for an internet advertisement object in accordance with a result of the first bid recommendation algorithm and a result of the second bid recommendation algorithm.

According to another embodiment, the at least one bid recommendation algorithm may include a first bid recommendation algorithm, and may further include acts of applying the first bid recommendation algorithm to the first object group, the bid recommendation algorithm operating on a first parameter, and applying the first bid recommendation algorithm to the second object group, the bid recommendation algorithm operating on a second parameter.

According to yet another embodiment, the plurality of internet advertisement objects may be a plurality of keywords. According to another embodiment, the first metric set and the second metric set may include measurements of clicks. According to still another embodiment, the first metric set and the second metric set may include measurements of impressions. According to yet another embodiment, the first metric set and the second metric set may include measurements of conversions.

According to another embodiment, the first client device and the second client device may be the same client device. According to yet another embodiment, the act of measuring the performance of at least one bid recommendation algorithm with respect to the second metric data set may include identifying a quality score of an advertisement. According to another embodiment, the act of measuring the performance of at least one bid recommendation algorithm with respect to the second metric data set may include identifying a profit margin of an advertisement.

According to another aspect of the present invention, a computer-readable medium is provided. The computer-readable medium comprises computer-executable instructions that, when executed on a processor of a server, perform a method for evaluating at least one bid recommendation algorithm. The method includes acts of retrieving a first metric data set associated with a plurality of internet advertisement objects, dividing the plurality of internet advertisement objects and the first metric set into a plurality of object groups, providing a first object group to a first client device, providing a second object group to a second client device, retrieving a second metric data set associated with the plurality of internet advertisement objects, and measuring the performance of the at least one bid recommendation algorithm with respect to the second metric data set.

According to one embodiment, the at least one bid recommendation algorithm may include a first bid recommendation algorithm and a second bid recommendation algorithm, and may further include acts of applying the first bid recommendation algorithm to the first object group, and applying the second bid recommendation algorithm to the second object group. In a further embodiment, the method may further include the act of placing a bid for an internet advertisement object in accordance with a result of the first bid recommendation algorithm and a result of the second bid recommendation algorithm.

According to another embodiment, the at least one bid recommendation algorithm may include a first bid recommendation algorithm, and may further include acts of applying the first bid recommendation algorithm to the first object group, the bid recommendation algorithm operating on a first parameter, and applying the first bid recommendation algorithm to the second object group, the bid recommendation algorithm operating on a second parameter.

According to yet another embodiment, the plurality of internet advertisement objects may be a plurality of keywords. According to another embodiment, the first metric set and the second metric set may include measurements of clicks. According to still another embodiment, the first metric set and the second metric set may include measurements of impressions. According to yet another embodiment, the first metric set and the second metric set may include measurements of conversions.

According to another embodiment, the first client device and the second client device may be the same client device. According to yet another embodiment, the act of measuring the performance of at least one bid recommendation algorithm with respect to the second metric data set may include identifying a quality score of an advertisement. According to another embodiment, the act of measuring the performance of at least one bid recommendation algorithm with respect to the second metric data set may include identifying a profit margin of an advertisement.

According to another aspect of the present invention, a system is provided. The system comprises a grouping engine configured to divide the plurality of internet advertisement objects and associated metric data sets into a plurality of object groups, a data transfer engine configured to send and receive the plurality of internet advertisement objects, the associated metric data sets, and the plurality of object groups, an analysis engine configured to measure the performance of at least one bid recommendation algorithm with respect to a metric data set, a metric database configured to store metric data, and at least one interface configured to allow interaction with the grouping engine, the data transfer engine, the analysis engine, and the metric database.

According to one embodiment, the system may include at least one client device configured to receive an object group from the data transfer engine and perform a bid recommendation algorithm on the object group. In a further embodiment, the at least one client device may further be configured to place a bid on an internet advertisement object. In a still further embodiment, the at least one client device may further comprise a user interface configured to allow a participant to interact with the bid recommendation algorithm.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects of the present invention may be implemented;

FIG. 2A shows an example bid recommendation algorithm selection system in the context of a distributed system in accordance with one embodiment of the invention;

FIG. 2B shows an example physical and logical diagram of the bid recommendation algorithm selection system of FIG. 2A in more detail;

FIG. 3 depicts an example process for analyzing the performance of multiple bid recommendation algorithms according to an embodiment;

FIG. 4 shows a client device interface in accordance with aspects of the present invention;

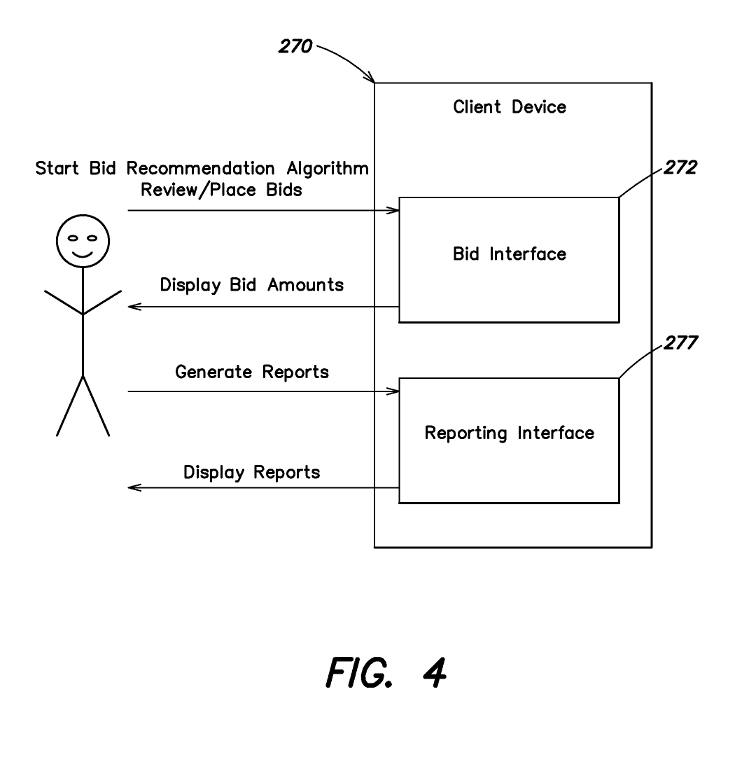

FIG. 5 illustrates a controller interface in accordance with aspects of the present invention; and

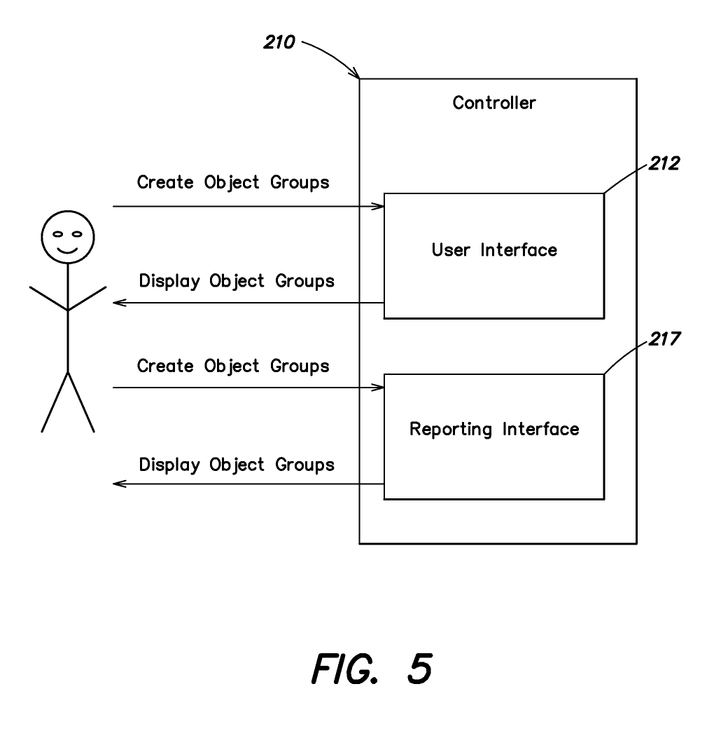

FIG. 6 illustrates a general purpose computer system suitable for implementing various aspects of the present invention.

### DETAILED DESCRIPTION

Many search engine advertisement programs, such as search engine advertisement program AdWords, available commercially on the Internet from GOOGLE, Inc., (Mountain View, Calif.), allow advertisers to bid on one or more keywords in an ongoing auction. The highest bidders at any given time for one or more particular keywords generally have their advertisements displayed as sponsored results in response to searches on those keywords. Bids for keywords may be submitted or updated on an ongoing basis.

Various types of metrics can be generated about search engine keyword advertising. For example, search engines may store and provide to advertisers the number of “impressions” for one or more keywords, that is, the number of times that particular advertisements associated with those keywords are displayed as sponsored results in response to a search. Search engines may also track the number of “clicks,” which is the number of times that a user has selected a link from an advertiser's advertisement. This link may redirect the user to a particular page on the advertiser's website. Further, the search engine, advertiser, or other party may track the number of “conversions,” or the number of times that a user has taken some action at the advertiser's website as a result of clicking on an advertisement, for example, by purchasing a product, signing up to receive more information, or otherwise interacting or transacting with the advertiser. “Partial conversions,” or situations where a customer aborts a transaction before completion, may also be tracked. This data may be aggregated for all advertisements associated with one or more particular keywords, so that the number of impressions, clicks, and/or conversions associated with each keyword may be determined.

Advertisers typically pay search engines to display their advertisements on either a “per impression” or “per click” basis or some multiple thereof, for example, per thousand impressions. Those metrics that are tracked by the search engine may be provided to the advertiser in the form of a summary and/or a detailed description, and may be provided by digital transmission or through other methods known in the art.

Metric data described herein can be aggregated into any number of derived metrics, for example, a click-to-conversion ratio, an impression-to-click ratio, and an impression-to-conversion ratio. Thus, in a situation where a sale is the desired conversion, an advertiser can determine the amount paid in advertising costs to generate one conversion. This information, when combined with an advertiser's target profit margin, can be used to generate a maximum bid that the advertiser is willing to pay to have its advertisement associated with a particular keyword or group of keywords while maintaining a desired profit margin.

Systems and methods for automatically generating bids in this manner are commercially available and provide advertisers with recommendations for placing bids on keyword groups with search engine providers. These systems may further optimize a generated bid by comparing the generated bid to historical metric data related to keywords or to advertisements by the advertiser or others. A generated bid may be placed with one or more search engines automatically by these systems, or the generated bid may be flagged for manual review by an operator of the system if the generated bid meets certain criteria, for example, if the generated bid falls outside a certain range of bids, or varies from a previous bid by a certain percentage. These systems may further apply sophisticated algorithms to historical data to generate a suggested bid. For example, a system may weigh recent data more heavily than older data in deriving a suggested bid.

At least one embodiment in accord with the present invention relates to a system and method with facilities, i.e., executable code and data structures, configured to divide a plurality of internet advertisement objects, such as keywords, into separate groups, to run one or more bid recommendation algorithms against those objects and place bids accordingly, and to assess the performance of the one or more bid recommendation algorithms in light of the search-related performance of those internet advertisement objects over a period of time.

The aspects disclosed herein, which are consistent with principles of the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to dividing a set of internet advertisement objects into groups, generating bids to have an advertisement associated with those internet advertisement objects, placing those bids with a search engine (or other advertisement system or ad network), and assessing the performance of the one or more bid recommendation algorithms in light of the search-related performance of those internet advertisement objects over a period of time. However, such a system may also perform other functions. Moreover, the systems described herein may be configured to include or exclude any of the functions discussed herein. Thus, the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

### Computer System

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system elements and components using a variety of hardware and software configurations, and the invention is not limited to any particular distributed architecture, network, or communication protocol.

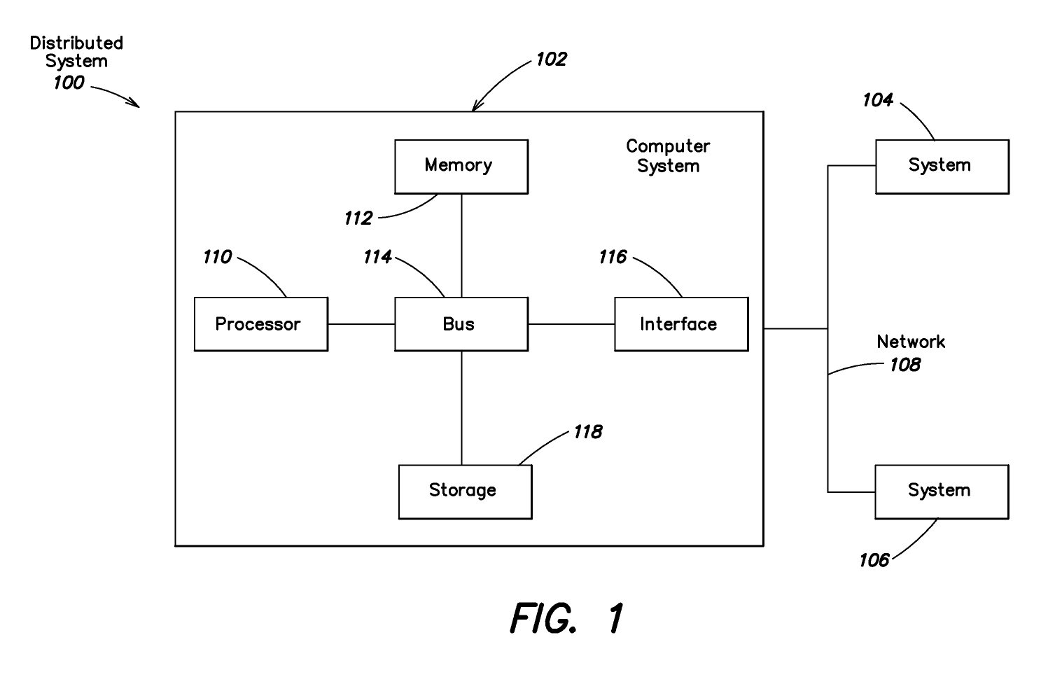

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA IIOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including the computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that manipulate data. The processor 110 may be a well-known, commercially available processor such as an Intel Pentium, Motorola PowerPC, SGI MIPS, Sun UltraSPARC, or Hewlett-Packard PA-RISC processor, or may be any other type of processor or controller as many other processors and controllers are available. As shown, the processor 110 is connected to other system elements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device. Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), and may include any communication coupling between system elements including specialized or standard computing bus technologies such as IDE, SCSI, PCI and InfiniBand. Thus, the bus 114 enables communications (for example, data and instructions) to be exchanged between system components of the computer system 102.

The computer system 102 also includes one or more interface devices 116 such as input devices, output devices and combination input/output devices. The interface devices 116 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

The storage system 118 may include a computer readable and writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, the processor 110 or some other controller may cause data to be read from the nonvolatile recording medium into another memory, such as the memory 112, that allows for faster access to the information by the processor 110 than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and the memory 112, and the invention is not limited thereto.

Further, the invention is not limited to a particular memory system or storage system. Although the computer system 102 is shown by way of example as one type of computer system upon which various aspects and functions in accord with the present invention may be practiced, aspects of the invention are not limited to being implemented on the computer system, shown in FIG. 1. Various aspects and functions in accord with the present invention may be practiced on one or more computers having a different architectures or components than that shown in FIG. 1. For instance, the computer system 102 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware elements included in computer system 102. A processor or controller, such as processor 110, may execute an operating system which may be, among others, a Windows-based operating system (for example, Windows NT, Windows 2000/ME, Windows XP, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed elements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle, Wash.; Oracle Database from Oracle of Redwood Shores, Calif.; and MySQL from Sun Microsystems of Santa Clara, Calif.; or integration software such as WebSphere middleware from IBM of Armonk, N.Y. However, a computer system running, for example, SQL Server may be able to support both aspects in accord with the present invention and databases for sundry applications not within the scope of the invention.

### Example System Architecture

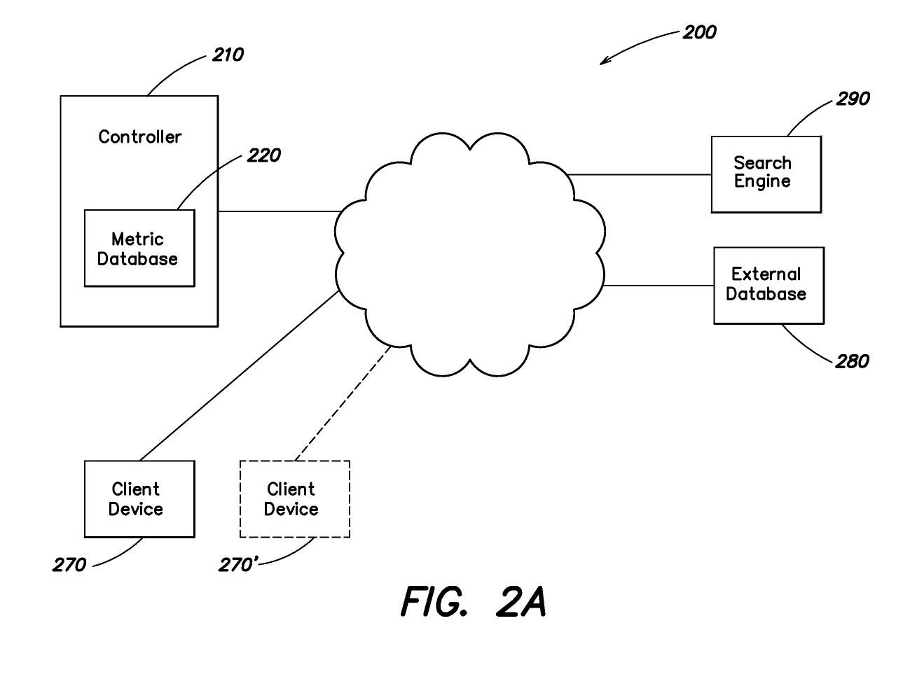

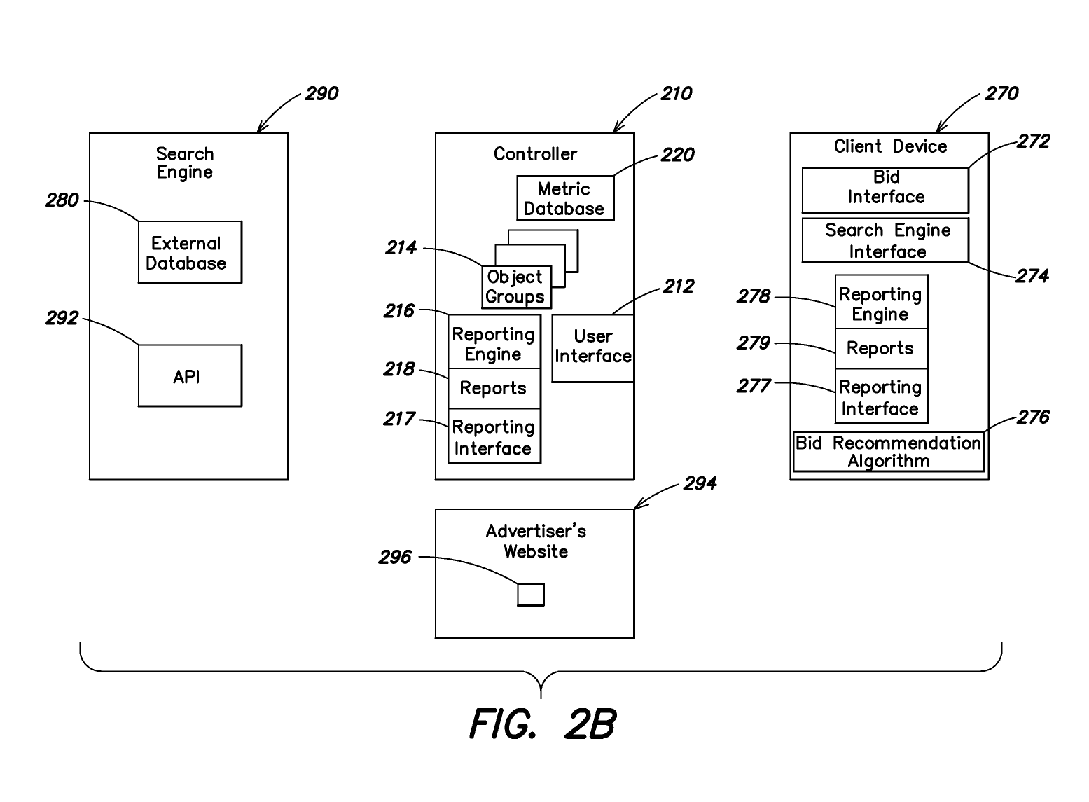

FIGS. 2A and 2B show block diagrams of a system 200 for selecting and optimizing a bid recommendation algorithm according to an embodiment of the present invention. The system 200 includes a controller 210 having a metric database 220. The system 200 further includes a client device 270 and an external database 280. The controller 210 is configured to retrieve metric data from the external database 280 and store it in the metric database 220, and to provide the metric data to the client device 270. The client device 270 is configured to run at least one bid recommendation algorithm on the metric data and, in some embodiments, place a bid on an internet advertisement object at a search engine 290 in accordance with the bid recommendation algorithm's recommendation. It will be appreciated that any number of client devices may be included. A second client device 270′ is shown in outline form to represent its optional inclusion in the system. Though all of the examples herein include at most two client devices, it should be appreciated that any use of the singular or plural form to refer to the one or more client devices 270 is for ease of illustration only. It is contemplated that any number of client devices may be included as permitted by system resources or dictated by need.

The controller 210, the external database 280, the client device 270, and the search engine 290 may be interconnected in a variety of ways and able to interact as described below. These sundry computer systems shown in FIGS. 2A and 2B each may include one or more computer systems. As discussed in regard to FIG. 1, such computer systems may have one or more processors or controllers, memory, and interface devices. For example, as seen in FIG. 2B, the controller 210 and the client device 270 may each include a respective interface 212, 272 for receiving commands or other input from a user and presenting information to the user. In certain embodiments, one or more of the elements depicted as being distinct elements in FIGS. 2A and 2B may be implemented on the same system. For example, one or more of the controller 210, the client device 270, and the external database 280 may be implemented on the same computer system. The particular configuration of system 200 depicted in FIGS. 2A and 2B is used for illustration purposes and it should be appreciated that embodiments of the invention may be practiced in other contexts, as the invention is not limited to a specific number of users or to a specific number or type of systems.

In several embodiments, the client device 270 may be configured to place generated bids with the search engine 290. The search engine 290 may provide an application programming interface (API) 292 that makes available sets of services, routines, data structures, object classes, and/or protocols through which the client device 270 can retrieve information or place bids. Such APIs are known in the art, for example, the GOOGLE AdWords API. The client device 270 may have one more search engine interfaces 274 configured to interact with the API 292 of the search engine 290.

Although one search engine 290 is shown in FIGS. 2A and 2B, this is for clarity purposes only. It will be appreciated that the controller 210 and the client device 270 may interact with and generate bids for multiple search engines.

In several embodiments, the controller 210 is a computer system configured to retrieve from the external database 280 metric data about internet search keywords in relation to sponsored results, for example, impressions and clicks associated with those keywords. In some embodiments the metric data may further include information about the date, day of the week, and the time of day that each underlying event, such as an impression or click, occurred.

Information may flow between the elements, components and subsystems of the controller 210 described herein using any technique. Such techniques include, for example, passing the information over the network via TCP/IP, passing the information between modules in memory and passing the information by writing to a file, database, or some other non-volatile storage device. In addition, pointers or other references to information may be transmitted and received in place of, or in addition to, copies of the information. Conversely, the information may be exchanged in place of, or in addition to, pointers or other references to the information. Other techniques and protocols for communicating information may be used without departing from the scope of the embodiments described herein.

In some embodiments, the controller 210 is communicatively coupled to the external database 280 to facilitate the retrieval of metric data. This connection may be provided over a computer network, such as the Internet, or may be coupled through an interconnection element such as a bus or data transfer cable. In some embodiments, the metric data may be made available for download, such as through an FTP or HTTP protocol-enabled connection. In other embodiments, it may be delivered by email. In still other embodiments, the controller 210 is not communicatively coupled to the external database 280, and the metric data is provided to the controller 210 on a physical storage medium such a CD-ROM, DVD-ROM, floppy disk, flash drive, or other storage medium known in the art.

In some embodiments, the external database 280 is maintained by and associated with the entity responsible for the search engine 290. In other embodiments, the external database 280 may be maintained by a third party provider, or may be maintained by the entity responsible for the controller 210. The external database 280 may take the form of any logical construction capable of storing information on a computer readable medium including flat files, indexed files, hierarchical databases, relational databases or object oriented databases. In addition, links, pointers, indicators and other references to data may be stored in place, of or in addition to, actual copies of the data. The data may be modeled using unique and foreign key relationships and indexes. The unique and foreign key relationships and indexes may be established between the various fields and tables to ensure both data integrity and data interchange performance.

In several embodiments, the controller 210 is also capable of acquiring or otherwise deriving additional metric data about keywords associated with sponsored results on a search engine. For example, the controller 210 may retrieve metric data about conversions or partial conversions from the external database 280, or this information may be provided by a third party, such as the advertiser. In some embodiments, a software component 296 may be placed on an advertiser's website 294 to allow the controller 210 to track conversion data. For example, a digital image that is hosted on a system associated with the controller 210 may be embedded in on one or more pages the advertiser's website 294 through inline or “hot” linking. The digital image may be very small, for example, 1 pixel by 1 pixel, and may be either visible or invisible to visitors to the advertiser's website. Whenever a user visits the advertiser's website 294, the user's web browser will automatically request the software component 296 (here, the digital image) from the system associated with the controller 210. In this way, the controller 210 is able to track the number of times that the advertiser's website 294 is visited. In other embodiments, data about conversions may be made available through a business or transaction system associated with the entity responsible for the controller 210.

According to various embodiments, a basic unit of an advertising object that may be used includes a keyword (e.g., such as those keywords used by an internet search engine). However, it will be appreciated that embodiments consistent with principles of the present invention may be used in conjunction with any advertising object for which bids may be placed and which may be displayed in response to some event. For example, the advertising object may be a textual phrase, a hyperlink, a textual advertisement, a graphic advertisement, or any other advertising object as is known in the art.

The metric data acquired by the controller 210 in any of the above manners may be stored in the metric database 220. According to the illustrated embodiment, the metric database 220 includes structures configured to store and retrieve content information. Content information may include or reference any information regarding content that is conveyable via a computer system. Examples of content information include, among others, the content and metadata describing the content such as content versions, content sizes, content edit histories, content storage locations, textual title or other identifiers of the content, information descriptive of the content, such as an textual abstract, and classification information, such as tags, that classify the content. The metric database 220 may take the form of any logical construction capable of storing information on a computer readable medium including flat files, indexed files, hierarchical databases, relational databases or object oriented databases. In addition, links, pointers, indicators and other references to data may be stored in place, of or in addition to, actual copies of the data. The data may be modeled using unique and foreign key relationships and indexes. The unique and foreign key relationships and indexes may be established between the various fields and tables to ensure both data integrity and data interchange performance.

In some embodiments, the metric database 220 may be distributed over a plurality of computer systems, for example, computer systems 104, 106 as seen in FIG. 1. The databases may be partitioned vertically or horizontally through a sharding process or other process. For example, the metric database 220 may be implemented on a system or systems running dbShards, commercially available from CodeFutures Corporation, Louisville, Colo.

In order that multiple bid recommendation algorithms can be run and tested, it is necessary to separate the keywords such that each keyword is associated with only one bid recommendation algorithm. The controller 210 is thus configured to create several object groups 214, and to divide the keywords and associated metric data stored in the metric database 220 into those object groups 214. It is desirable that the object groups 214 be largely similar according to one or more aspects so as to create a controlled testing situation. Thus, the controller 210 may be configured to derive a measure of similarity for the object groups 214 and create the object groups 214 accordingly. For example, the controller 210 may create several object groups 214 having keywords having nearly identical or similar impression-to-click ratios among the object groups 214. In other embodiments, the controller 210 may evaluate the profitability or return-on-investment (ROI) of one or more keywords and create object groups 214 accordingly. For example, the controller 210 may create object groups 214 based on the average “cost per acquisition” (CPA) of a keyword. This metric may represent the average amount of money that must be bid on the keyword in order to generate a new sale, lead, or other desirable event.

The mechanism used to divide the keywords into object groups 214 may employ “hill climbing” algorithms or other processes by which optimally similar groups can be created. For example, in some embodiments, the keywords may be randomly separated into two object groups 214. The controller 210 may then evaluate the object groups 214 for their initial similarity. The controller 210 may then make a series of swaps of keywords between the object groups 214, and identify any swaps that make the object groups 214 more similar. This process may continue until no swaps can be made that would make the objects groups 214 more similar. Through such an iterative approach, several object groups 214 can be created that are optimally similar according to one or more criteria.

In several embodiments, the controller 210 is also communicatively coupled to the client device 270 in order to allow for the exchange of data between the components. This connection may be provided over a computer network, such as the Internet, or may be coupled an interconnection element such as a bus or data transfer wire. In some embodiments, the metric data may be made available for download from one or both of the controller 210 and the client device 270, such as through an FTP or HTTP protocol-enabled connection. In other embodiments, the metric data may be delivered by email. In still other embodiments, the controller 210 is not communicatively coupled to the external database, and the metric data is provided to the controller 210 on a physical storage medium such a CD-ROM, DVD-ROM, floppy disk, flash drive, or other physical storage medium as are known in the art.

In several embodiments, the client device 270 is configured to receive object groups 214 or metric data from the controller 210 and execute one or more bid recommendation algorithms 276. In some embodiments, the bid recommendation algorithms 276 or parameters for controlling them may be provided by the controller 210. In other embodiments, the bid recommendation algorithms 276 or parameters may be determined independently of the controller 210. The client device 270 may be a “thin client” as are known in the art, such that processing and execution of the bid recommendation algorithms 276 is controlled or performed by the controller 210. In other embodiments, the client device 270 may be a stand-alone system, for example, a PC, mobile device, or other computing device, and may perform these functions itself.

In several embodiments, the client device 270 is provided with the bid interface 272 such that a person (hereinafter referred to as a “participant”) interacting with the bid recommendation algorithm 276, placing bids, or viewing reports or results can interact with the client device 270. In some embodiments, the client device 270 may be provided with the bid interface 272 as a software component by the controller 210. In other embodiments, the controller 210 may merely deliver the object groups 214 to the client device 270 by a data transfer protocol, such as email, or by other mechanism.

### Exemplary Methods

Having described various aspects of a system for comparing bid recommendation algorithms, the operation of such a comparison system is now described.

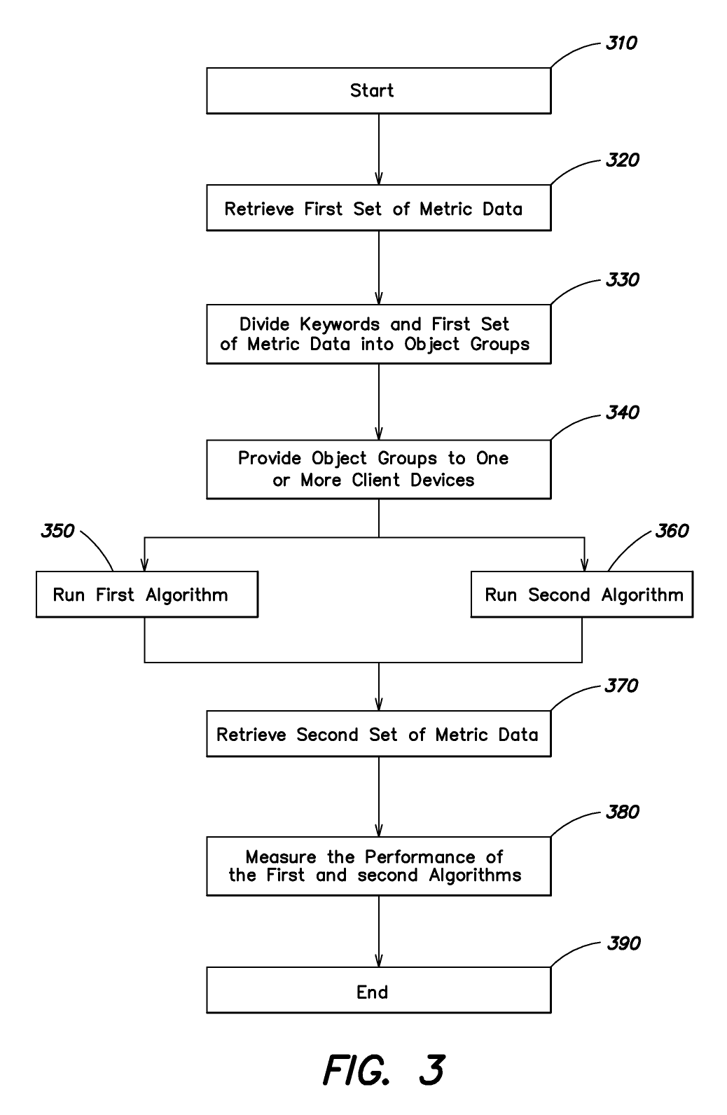

A method according to one embodiment of the invention is described with reference to FIG. 3.

The method starts at act 310.

In act 320, the controller 210 retrieves metric data associated with search engine sponsored result keywords from the external database 280. This metric data may be stored in the metric database 220 or it may otherwise be retained in a volatile or non-volatile memory until the next act. In some embodiments, the controller 210 may retrieve all of the keywords and associated metric data associated with a particular advertiser, campaign, or keyword group from the external database 280 in this act. In other embodiments, the controller 210 may already maintain a list of keywords and may retrieve only the metric data associated with those keywords from the external database 280.

In some embodiments, the controller 210 may only retrieve metric data for a certain time period or time of day. For example, it may be known that users performing searches during off-peak hours, for example, nights and weekends, are less likely to click on a sponsored result. Thus, in order to obtain consistent search results, the controller 210 may only retrieve metric data for peak hours, for example. In some embodiments, act 320 may be performed in response to an automated or user action at the controller 210. In other embodiments, act 320 may be automatically performed on a schedule or at regular intervals. In act 320, the controller 210 may further retrieve or otherwise generate or obtain conversion data, for example, from the external database 280 or from a third party. This information may be in detailed or summary form, and may correlate a particular impression or click associated with a keyword to a particular conversion, for example, a sale, sign-up, or sales lead.

In some embodiments, the controller 210 may calculate derived statistics to be provided to the client device 270. However, it will be appreciated that in many embodiments the bid recommendation algorithms 276 executed by the client device 270 may perform their own sophisticated analysis, so it is preferable to deliver the raw statistics, such as impressions, clicks, and conversions, to the client device 270 and allow bid recommendation algorithms 276 running on the client device 270 to generate bids, either automatically or through the interaction of a participant.

In act 330, the keywords are divided into the object groups 214 such that each keyword will be associated with only one bid recommendation algorithm 276. Further, it is desirable that the keywords in each object group 214 be largely similar according to one or more aspects so as to create a controlled testing situation. For example, if a user desired to identify which of two bid recommendation algorithms generated the most profitable bid recommendations for keywords that result in a high number of impressions, then it would be desirable that the two object groups 214 should consist of keywords that result in substantially the same number of impressions. This will ensure that any differences in performance are largely attributable to differences between the algorithms themselves, rather than the keywords for which they are generating bid recommendations. Deriving a measure of similarity for the object groups 214 may entail resort to statistical analysis that is well-known in the art, such as calculating the mean, standard deviation, or other statistical measure of one or more metrics or derived metrics for each object group 214. For example, the similarity of the object groups 214 may be calculated by comparing the mean and standard deviation of the impressions for all of the keywords in one object group 214 to that of another group.

In other embodiments, objects may be grouped according to linguistic characteristics of the objects, for example, the frequency of the word in a particular language, or average keyword length. As another example, it may be desirable that the object groups 214 may have similar proportions of keywords containing brand names.

It is to be appreciated that keywords may be selected at various levels of aggregation according to business rules. For example, it may desirable to include in the object groups 214 all of the keywords for a particular product, a particular advertising campaign, or a particular account. In some embodiments, it may desirable to allow one or more participants to individually identify the keywords or keyword groups to be included.

In some embodiments, the controller 210 may divide the entire set of keywords into two or more object groups 214 to be provided to one or more client devices 270. In other embodiments, the controller 210 may only provide some of the keywords to the client device 270, i.e., some keywords may be retained for some for other purposes, such as performing other tests, or carrying on normal bid generation in the course of business. In some embodiments, substantially the same number of keywords may be provided to each client device 270. In other embodiments, some other proportional division may be desired. For example, a larger portion of the keywords may be assigned to one object group 214, while a smaller portion may be assigned to another object group 214. In some embodiments where a double- or triple-blind test is desired, the controller 210 may divide the keywords into the object groups 214 and provide them to the one or more client devices 270 while preventing the keywords from being displayed to users of the controller 210 and/or the client device 270 until the bid recommendation algorithms 276 have completed running. In another embodiment, the bid recommendation amounts may be kept secret from other participants. In still another embodiment, the participants may be unaware that they are participating in a comparison at all. For example, they may be provided a set of keywords for which to generate bid amounts without realizing that other participants or keywords exist.

In act 340, the keywords and metric data are provided to the one or more client devices 270.

In act 350 a first bid recommendation algorithm 276 is run on the first object group 214, and in act 360, a second bid recommendation algorithm 276′ (not shown) is run on the second object group 214′ (not shown).

In one embodiment, the function of the first bid recommendation algorithm 276 is similar to but incrementally different than the second bid recommendation algorithm 276′. The results derived from each bid recommendation algorithm 276, 276′ in this embodiment can be compared to identify possible improvements to a bid recommendation algorithm currently being used in the course of business to generate actual bids, for example. In this embodiment, both the first bid recommendation algorithm 276 and the second bid recommendation algorithm 276′ may be run on a single client device 270 or on two different client devices 270 and 270′, either concurrently or at different times.

In another embodiment, the first and second bid recommendation algorithms 276, 276′ may function in the same manner, but may be given different values for one or more parameters. For example, in one embodiment, the first bid recommendation algorithm 276 may generate a bid recommendation as described above, and then increase the value of the bid by 10%. The second bid recommendation algorithm 276′ may generate the same bid recommendation but apply a different increase/decrease percentage, for example, a 0% increase. In this manner the invention can be used to optimize the values of parameters used in the bid recommendation algorithms 276, 276′. If it is desirable to minimize risk, this embodiment may be configured to “hedge” the bids. For example, if the first bid recommendation algorithm 276 applies a 10% increase, the second bid recommendation algorithm 276′ may be configured to apply a corresponding 10% decrease. In this embodiment, both the first bid recommendation algorithm 276 and the second bid recommendation algorithm 276′ may be run on a single client device 270 or on two different client devices 270′, either concurrently or at different times.

In yet another embodiment, the first and second bid recommendation algorithms may be implemented differently or have completely different functionality. For example, in act 340, the keywords and metric data may have been provided to different search engine marketing companies, who in acts 350 and 360 will apply their own bid recommendation algorithms to the object group assigned to them. In this embodiment, certain testing rules may be imposed. For example, in order to control the testing conditions, a rule may be imposed that bids may only be generated and placed at particular times and/or days of the week, since, as described above, click and conversion activity may vary at different times of the day and week.

In another embodiment, at least two client devices 270 may be employed, and one or more participants may interact with a bid interface 272 at the client devices 270 to develop bid recommendations. In some embodiments, the client devices 270 may provide the participants with interactive bid recommendation software as is known in the art. In other embodiments, the participants may develop bid recommendations by other methods as are known in the art and record their bid recommendations and/or place their bids at the client devices 270. In this manner, participants can compete against each other by performing the normal duties associated with keyword bidding.

In any of these described embodiments, it is to be appreciated that varying levels of automation and manual intervention may be provided. For example, the bid recommendation algorithms may present a user with a bid or range of bids from which to choose, allowing the user to modify or disregard the bid recommendation before actually placing the bid. In other embodiments, the bid recommended by the bid recommendation algorithms is automatically placed by the controller 210 or the client device 270.

Acts 350 and 360 are completed when the bid recommendations from the first bid recommendation algorithm and the second bid recommendation algorithm have been placed with the search engine or other entity responsible for accepting keyword bids and providing sponsored results accordingly. In some embodiments, the participants may place the bids directly with the search engine, either through use of the bid interface 272 of client device 270 or by another method. In other embodiments, the bids may be entered into a bid management software application, which places the bid. The bid management software application may further verify or modify the bid recommendation. For example, the application may confirm that the bid is a positive number representing a valid amount of currency. In some embodiments, the application may automatically place bids under some conditions, but flag for manual review bids that meet certain outlier or other criteria. For example, a bid may be refused or flagged for review prior to being placed if it falls above a certain predefined ceiling, or below a certain predefined floor. In some embodiments, a bid may be refused or flagged for review prior to being placed if it varies from previous similar bids by a certain amount or percentage, for example.

Because the relative performance of the bid recommendation algorithms cannot be assessed until some amount of differentiation can be determined in their respective results, act 370 begins after certain criteria have been met, for example, a certain amount of time or suitable amount of metric data has been accrued. In other embodiments, participants may place bids on an ongoing basis as frequently as desired or according to some predefined limitations until the end of the metric data accrual period. In other embodiments, bids may only be entered at or prior to the beginning of this metric data accrual period.

Act 370 is thus triggered at the end of the metric data accrual period or according to some other requirement allowing for some differentiation in the performance of the keywords in the various object groups. In some embodiments, the end of the metric data accrual period may occur at some scheduled time. For example, a test may be scheduled to run for a particular length of time, such as a week or a month. In some embodiments, the metric data accrual period may be ended manually at a time chosen by a system administrator.

In act 370 the controller 210 retrieves from the external database 280 metric data about the performance of the keywords on which the bids were placed in acts 350 and 360. For example, the controller 210 may retrieve metric data about keyword bids/costs, impressions, clicks, and conversions in relation to the keywords on which bids were placed.

In act 380, the performances of the first bid recommendation and the second bid recommendation algorithm are measured. A calculation or performance algorithm, such as reporting engines 216, 278 may be applied to some or all of the second set of metric data to assess the performance of the first bid recommendation algorithm 276 and the second bid recommendation algorithm 276′ according to one or more criteria. For example, by knowing the actual amount spent on a particular keyword through a total number of impressions and/or clicks, the cost of advertising with that keyword can be determined. The CPA and amount of revenue each keyword generated through conversions can also be determined. Thus, knowing the cost and revenue associated with each keyword, a profit level or ROI can be calculated for that keyword. This value can be aggregated across multiple keywords to generate an average profitability associated with advertising with that group of keywords when bids are generated according a particular bid recommendation algorithm.

In other embodiments, different measures may be used to evaluate the relative performance of the bid recommendation algorithms. For example, the algorithms may be evaluated according to the net margin generated by the keywords for which bids were generated. In some embodiments, the algorithms may be evaluated according to a proprietary quality score assigned by a search engine to the advertisements associated with those keywords. In still other embodiments, raw metrics may be used to perform the evaluation. For example, algorithms may be evaluated based on the number of impressions, conversions, or clicks generated by the keywords on which bids were placed.

In some embodiments, bid recommendation algorithms may be evaluated according to their ability to increase rankings assigned to advertisements associated with keywords for which bids were placed. For example, the GOOGLE search engine grades every advertisement participating in its AdWords search engine advertisement program with a “quality score” (QS) without revealing how this number is calculated. Advertisements having a higher QS are shown more often and are required to pay a lower price per click than a similar advertisement having a lower QS. Thus, it may be desirable to evaluate the change in QS assigned to a particular advertisement that occurs as a result of the advertisement being associated with one or more keywords. A bid recommendation algorithm that maximizes the QS of the advertisement may be identified.

In some embodiments, the results may identify which of the first bid recommendation and second bid recommendation algorithm is preferred according to one or more criteria. In some embodiments, the results may be provided in a reporting application with some level of detail, such as the number of impressions, clicks, and conversions associated with one or more keywords on which bids were placed, as well as the bid amount. Calculated results such as profitability may also be provided in report form. One or more reports 218, 279 may be displayed through one or more of the reporting interfaces 217, 277 on the controller 210 or the client device 270. The reporting interfaces 217, 277 may provide the capability to “drill down” into the reports 218, 279 to present the underlying data at a desired level of detail. The reporting interface 217, 277 may be developed on an existing software framework, such as .NET, commercially available from THE MICROSOFT CORPORATION, Redmond, Wash.

The method 300 ends at act 390.

The method 300 depicts one particular sequence of acts in a particular embodiment. The acts included in each of these processes may be performed by, or using, one or more computer systems specially configured as discussed herein. Thus the acts may be conducted by external entities, such as users or separate computer systems, by internal elements of a system or by a combination of internal elements and external entities. Some acts are optional and, as such, may be omitted in accord with one or more embodiments. Additionally, the order of acts can be altered, or other acts can be added, without departing from the scope of the present invention. In at least some embodiments, the acts have direct, tangible and useful effects on one or more computer systems, such as storing data in a database or providing information to external entities.

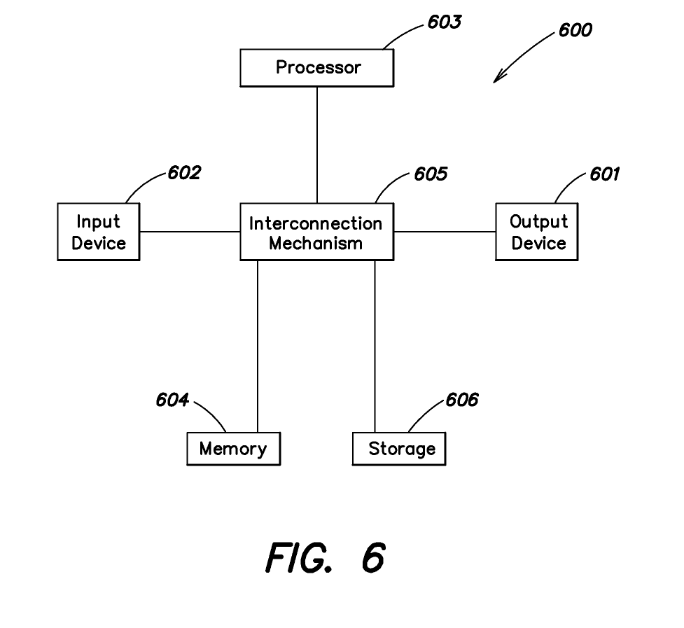

The above defined process 300 according to several embodiments may be implemented on one or more general-purpose computer systems. For example, various aspects of the invention may be implemented as specialized software executing in a general-purpose computer system 600 such as that shown in FIG. 6. Computer system 600 may include one or more output devices 601, one or more input devices 602, a processor 603 connected to one or more memory devices 604 through an interconnection mechanism 605 and one or more storage devices 606 connected to interconnection mechanism 605. Output devices 601 typically render information for external presentation and examples include a monitor and a printer. Input devices 602 typically accept information from external sources and examples include a keyboard and a mouse. Processor 603 typically performs a series of instructions resulting in data manipulation. Processor 603 is typically a commercially available processor such as an Intel Pentium, Motorola PowerPC, SGI MIPS, Sun UltraSPARC, or Hewlett-Packard PA-RISC processor, but may be any type of processor. Memory devices 604, such as a disk drive, memory, or other device for storing data is typically used for storing programs and data during operation of the computer system 600. Devices in computer system 600 may be coupled by at least one interconnection mechanism 605, which may include, for example, one or more communication elements (e.g., busses) that communicate data within system 600.

The storage device 606, discussed in greater detail below, typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This other memory is typically a volatile, random access memory such as a dynamic random access memory (DRAM), static memory (SRAM). This other memory may be located in a storage device or in a memory device. The processor generally manipulates the data within the memory device 604 or other memory and then copies the data to the medium after processing is completed. A variety of mechanisms are known for managing data movement between the medium and the memory device 604 or other memory and the invention is not limited thereto. The invention is not limited to a particular memory device 604 or storage device 606.

Computer system 600 may be implemented using specially programmed, special purpose hardware, or may be a general-purpose computer system that is programmable using a high-level computer programming language. For example, computer system 600 may include cellular phones, personal digital assistants and/or other types of mobile computing devices. Computer system 600 usually executes an operating system which may be, for example, the Windows 95, Windows 98, Windows NT, Windows 2000, Windows ME, Windows XP, Windows Vista or other operating systems available from the Microsoft Corporation, MAC OS System X available from Apple Computer, the Solaris Operating System available from Sun Microsystems, or UNIX operating systems available from various sources (e.g., Linux). Many other operating systems may be used, and the invention is not limited to any particular implementation. For example, an embodiment of the present invention may build a text analytics database using a general-purpose computer system with a Sun UltraSPARC processor running the Solaris operating system.

Although computer system 600 is shown by way of example as one type of computer system upon which various aspects of the invention may be practiced, it should be appreciated that the invention is not limited to being implemented on the computer system as shown in FIG. 6. Various aspects of the invention may be practiced on one or more computers having a different architecture or components than that shown in FIG. 6. To illustrate, one embodiment of the present invention may receive search criteria using several general-purpose computer systems running MAC OS System X with Motorola PowerPC processors and several specialized computer systems running proprietary hardware and operating systems.

As discussed below, one or more portions of the system may be distributed to one or more computers coupled to communications network. These computer systems may also be general-purpose computer systems. For example, various aspects of the invention may be distributed among one or more computer systems configured to provide a service (e.g., servers) to one or more client computers, or to perform an overall task as part of a distributed system. More particularly, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). To illustrate, one embodiment may expert search engine results though a browser interpreting HTML forms and may store document information in a document database using a data translation service running on a separate server.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof. For example, a meaning taxonomy user interface may be implemented using a Microsoft Excel spreadsheet while the application designed to tagged documents associated with meaning loaded entities may be written in C++.

It should be appreciated that a general-purpose computer system in accord with the present invention may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif., and MySQL from MySQL AB of UPPSALA, Sweden and WebSphere middleware from IBM of Armonk, N.Y. If SQL Server is installed on a general-purpose computer system to implement an embodiment of the present invention, the same general-purpose computer system may be able to support databases for sundry applications.

Based on the foregoing disclosure, it should be apparent to one of ordinary skill in the art that the invention is not limited to a particular computer system platform, processor, operating system, network, or communication protocol. Also, it should be apparent that the present invention is not limited to a specific architecture or programming language.

Any reference to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim elements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A method for evaluating at least one bid recommendation algorithm, comprising acts of:
retrieving a first metric data set associated with a plurality of internet advertisement objects;
dividing the plurality of internet advertisement objects and the first metric set into a plurality of object groups;
providing a first object group to a first client device;
to providing a second object group to a second client device;
retrieving a second metric data set associated with the plurality of internet advertisement objects; and
measuring the performance of the at least one bid recommendation algorithm with respect to the second metric data set.

2. The method of claim 1, wherein the at least one bid recommendation algorithm includes a first bid recommendation algorithm and a second bid recommendation algorithm, further comprising acts of:
applying the first bid recommendation algorithm to the first object group; and
applying the second bid recommendation algorithm to the second object group.

3. The method of claim 2, further comprising the act of placing a bid for an internet advertisement object in accordance with a result of the first bid recommendation algorithm and a result of the second bid recommendation algorithm.

4. The method of claim 1, wherein the at least one bid recommendation algorithm includes a first bid recommendation algorithm, further comprising acts of:
applying the first bid recommendation algorithm to the first object group, the bid recommendation algorithm operating on a first parameter; and
applying the first bid recommendation algorithm to the second object group, the bid recommendation algorithm operating on a second parameter.

5. The method of claim 1, where the plurality of internet advertisement objects is a plurality of keywords.

6. The method of claim 1, wherein the first metric set and the second metric set comprise measurements of clicks.

7. The method of claim 1, wherein the first metric set and the second metric set comprise measurements of impressions.

8. The method of claim 1, wherein the first metric set and the second metric set comprise measurements of conversions.

9. The method of claim 1, wherein the first client device and the second client device are the same client device.

10. The method of claim 1, wherein the act of measuring the performance of at least one bid recommendation algorithm with respect to the second metric data set includes identifying a quality score of an advertisement.

11. The method of claim 1, wherein the act of measuring the performance of at least one bid recommendation algorithm with respect to the second metric data set includes identifying a profit margin of an advertisement.

12. A computer-readable medium comprising computer-executable instructions that, when executed on a processor of a server, perform a method for evaluating at least one bid recommendation algorithm, the method comprising acts of:
retrieving a first metric data set associated with a plurality of internet advertisement objects;
dividing the plurality of internet advertisement objects and the first metric set into a plurality of object groups;
providing a first object group to a first client device;
providing a second object group to a second client device;
retrieving a second metric data set associated with the plurality of internet advertisement objects; and
measuring the performance of the at least one bid recommendation algorithm with respect to the second metric data set.

13. The computer-readable medium of claim 12, the method further comprising acts of:
applying a first bid recommendation algorithm to the first object group; and
applying a second bid recommendation algorithm to the second object group.

14. The computer-readable medium of claim 13, the method further comprising the act of placing a bid for an internet advertisement object in accordance with a result of the first bid recommendation algorithm and a result of the second bid recommendation algorithm.

15. The computer-readable medium of claim 12, the method further comprising acts of:
applying a bid recommendation algorithm to the first object group, the bid recommendation algorithm operating on a first parameter; and
applying the bid recommendation algorithm to the second object group, the bid recommendation algorithm operating on a second parameter.

16. The computer-readable medium of claim 12, wherein the plurality of internet advertisement objects is a plurality of keywords.

17. The computer-readable medium of claim 12, wherein the first metric set and the second metric set comprise measurements of clicks.

18. The computer-readable medium of claim 12, wherein the first metric set and the second metric set comprise measurements of impressions.

19. The computer-readable medium of claim 12, wherein the first metric set and the second metric set comprise measurements of conversions.

20. The computer-readable medium of claim 12, wherein the first client device and the second client device are the same client device.

21. The method of claim 12, wherein the act of measuring the performance of at least one bid recommendation algorithm with respect to the second metric data set includes identifying a quality score of an advertisement.

22. The method of claim 12, wherein the act of measuring the performance of at least one bid recommendation algorithm with respect to the second metric data set includes identifying a profit margin of an advertisement.

23. A system comprising:
a grouping engine configured to divide the plurality of internet advertisement objects and associated metric data sets into a plurality of object groups;
a data transfer engine configured to send and receive the plurality of internet advertisement objects, the associated metric data sets, and the plurality of object groups;
an analysis engine configured to measure the performance of at least one bid recommendation algorithm with respect to a metric data set;
a metric database configured to store metric data; and
at least one interface configured to allow interaction with the grouping engine, the data transfer engine, the analysis engine, and the metric database.

24. The system of claim 23, further comprising:
at least one client device configured to receive an object group from the data transfer engine and perform a bid recommendation algorithm on the object group.

25. The system of claim 24, wherein the at least one client device is further configured to place a bid on an internet advertisement object.

26. The system of claim 25, wherein the at least one client device further comprises a user interface configured to allow a participant to interact with the bid recommendation algorithm.
